(19) United States
(12) Patent Application Publication
(10) Pub. No.: US 2017/0357946 A1
(43) Pub. Date: Dec. 14, 2017

(54) Clinical knowledge driven healthcare scheduling

(71) Applicant: KONINKLIJKE PHILIPS N.V., Eindhoven (NL)

(72) Inventors: Qin Zhu, Shanghai (CN); Yihui Fan, Shanghai (CN); Zuofeng Li, Shanghai (CN); Richard Vdovjak, Eindhoven (NL)

(21) Appl. No.: 14/572,984

(22) Filed: Dec. 17, 2014

(51) Int. Cl. G06Q 10/10; G06Q 50/22

(52) U.S. Cl. CPC G06Q 10/1095; G06Q 50/22

(57) ABSTRACT

Embodiments of the present invention relate to clinical knowledge driven healthcare scheduling. There is disclosed a method of healthcare scheduling, comprising receiving a request to generate an appointment for a target user, the request at least containing identification of the target user; obtaining clinical knowledge associated with the target user by accessing a knowledge base, the clinical knowledge at least indicating time constraints and at least one required resource for the appointment; generating a group of prioritized candidate appointments by processing the request at least partially based on the obtained clinical knowledge, each of the candidate appointments being represented at least by appointment time and a priority; and selecting at least one recommended appointment from the group of prioritized candidate appointments based on availability of the at least one required resource. Corresponding apparatus, system and computer program product are also disclosed.

### FIELD OF THE INVENTION

Embodiments of the present invention generally relate to clinical knowledge driven healthcare scheduling, and particularly to a method, apparatus, system and computer program product for generating an appointment recommendation based on the clinical knowledge.

### BACKGROUND OF THE INVENTION

Healthcare scheduling refers to the process of making an appointment for a patient to visit a doctor or hospital with specific healthcare resources at a specific time. As used herein, the term “resource” refers to medical service provider, medical device, patient bed, room, or anything required for the appointment. As an example, scheduling is commonly used in follow-up procedures which can improve the clinical efficiency in particular in a resource limitation environment.

Traditionally, scheduling is done manually by healthcare practitioners such as nurses. For example, the booking of appointments has traditionally been done over the telephone. However, in the case of manual scheduling, it is very difficult to match a great variety of patient needs with the available resources. Additionally, manual scheduling is time consuming and inconvenient to both patients and healthcare practitioners.

Moreover, the inventors of the present application have realized that healthcare practitioners like nurses are generally unable to schedule an appointment such that it is most suitable for patients. In everyday practice, in the case of a request for an appointment from a patient, the nurse selects date and time, for example, by viewing the calendar. For example, when the patient requests an appointment for three months after discharge, the nurse selects a date that is about three months after the discharge date. Then the nurse checks whether the resources, such as the physician and a room, are available at the selected time. If not, date and/or time will be manually adjusted to match the availability of the resources. For example, the nurse randomly selects a new date, which is a certain number of days prior to or later than the previously selected date, on which new date the resources required for the appointment are available. However, there are appointments that should not be postponed or advanced. Thus, it will be appreciated that appointment recommendations generated by such manual scheduling are often not optimal with respect to the clinical requirements for the specific appointment or situation of the specific patient, which negatively impacts the patient's outcome.

Attempts have been made to automate the scheduling process. However, in the case of these known solutions, the appointment information simply is usually calculated based on predefined resource constraints. In other words, at present, automated scheduling just computerizes the aforementioned manual process and thus has the same drawbacks.

### SUMMARY OF THE INVENTION

In order to address the above-mentioned and other potential problems, embodiments of the present invention propose a method, apparatus, system, and computer program product for healthcare scheduling, which are at least partially based on clinical knowledge.

In one aspect, embodiments of the present invention provide a method of healthcare scheduling. The method comprises the steps of: receiving a request to generate an appointment for a target user, the request at least containing identification of the target user; obtaining clinical knowledge associated with the target user by accessing a knowledge base, the clinical knowledge at least indicating time constraints and at least one required resource for the appointment; generating a group of prioritized candidate appointments by processing the request at least partially based on the obtained clinical knowledge, each of the candidate appointments being represented at least by appointment time and a priority; and selecting at least one recommended appointment from the group of prioritized candidate appointments based on availability of the at least one required resource. The method can be implemented using a computer.

Other embodiments in this regard include a computer program product for healthcare scheduling. The computer program product being tangibly stored on a non-transient computer-readable medium and comprising machine-executable instructions which, when executed, cause the machine to perform steps of this method.

In another aspect, embodiments of the present invention provide an apparatus for healthcare scheduling. The apparatus comprises: a request receiving unit configured to receive a request to generate an appointment for a target user, the request at least containing identification of the target user; a knowledge obtaining unit configured to obtain clinical knowledge associated with the target user by accessing a knowledge base, the clinical knowledge at least indicating time constraints and at least one required resource for the appointment; a candidate(?) generating unit configured to generate a group of prioritized candidate appointments by processing the request at least partially based on the obtained clinical knowledge, each of the candidate appointments being represented at least by appointment time and a priority; and a recommendation selecting unit configured to select at least one recommended appointment from the group of prioritized candidate appointments based on availability of the at least one required resource.

In yet another aspect, embodiments of the present invention provide a system for healthcare scheduling. The system comprises: the apparatus as described above; the knowledge base configured to store the clinical knowledge; and a resource checker configured to store usage of one or more resources and report the usage of the at least one required resource to the apparatus.

These embodiments of the present invention can be implemented to realize one or more of the following advantages. In accordance with embodiments of the present invention, an appointment for a target user is no longer made only in dependence on availability of the resource. Rather, clinical knowledge associated with the appointment for the target user will be obtained and used to generate a group of candidate appointments that are prioritized. Then the resource availability may be checked with respect to those candidate appointments according to their priorities to determine an appropriate appointment for recommendation to the user. By involving the clinical knowledge related to individual users, the appointment recommendation can be made in a more suitable manner. For example, by obtaining and using the clinical knowledge related to the follow-up program in which the target user participates and/or the health condition of the target user, the appointment can be made in dependence on the clinical requirements for the specific follow-up appointment and/or in dependence on the situation of the target user. Furthermore, clinical knowledge including clinical requirements and a patient's health condition are known to be very complicated and may be represented in various ways and/or may keep increasing, and so it is not simple to give an appointment recommendation based on both the clinical knowledge and the resource availability, which may result in a highly computationally complex task. However, by prioritizing the candidate appointments based on the clinical knowledge, it is possible to transform the impacts or constraints of all kinds of clinical knowledge into the same parameter, i.e. the priority, which not only reduces the complexity of the appointment recommendation, but which also makes the proposed method and system more scalable, especially when the clinical knowledge is accumulatively increasing.

Other features and advantages of embodiments of the present invention will also be understood from the following description of exemplary embodiments when read in conjunction with the accompanying drawings, which illustrate, by way of example, spirit and principles of the present invention.

### BRIEF DESCRIPTION OF THE DRAWINGS

Details of one or more embodiments of the present invention are set forth in the accompanying drawings and the description below. Other features, aspects, and advantages of the invention will become apparent from the description, the drawings, and the claims, wherein:

FIG. 1 is a flowchart illustrating a method of healthcare scheduling in accordance with an exemplary embodiment of the present invention;

FIG. 2 is a block diagram illustrating an apparatus for healthcare scheduling in accordance with an exemplary embodiment of the present invention;

FIG. 3 is a block diagram illustrating a system for healthcare scheduling in accordance with an exemplary embodiment of the present invention; and

FIG. 4 is a block diagram illustrating a computer suitable for implementing exemplary embodiments of the present invention.

Throughout the figures, same or similar reference numbers indicate same or similar elements.

### DETAILED DESCRIPTION OF EMBODIMENTS

In general, embodiments of the present invention provide a method, system, and computer program product for healthcare scheduling. The appointment for a target user is no longer made only in dependence on resource availability. Rather, clinical knowledge in relation to the target user will be obtained and used to generate a group of candidate appointments. In particular, in accordance with embodiments of the present invention, the candidate appointments are prioritized according to the relations between their respective appointment time and a desired appointment time. Then, availability of the required resource(s) is checked with respect to those candidate appointments according to their priorities. In this manner, it is possible to determine one or more recommended appointments which may be displayed for the user selection. By involving the clinical knowledge associated with individual users in the appointment recommendation, healthcare scheduling can be done in a suitable, accurate manner.

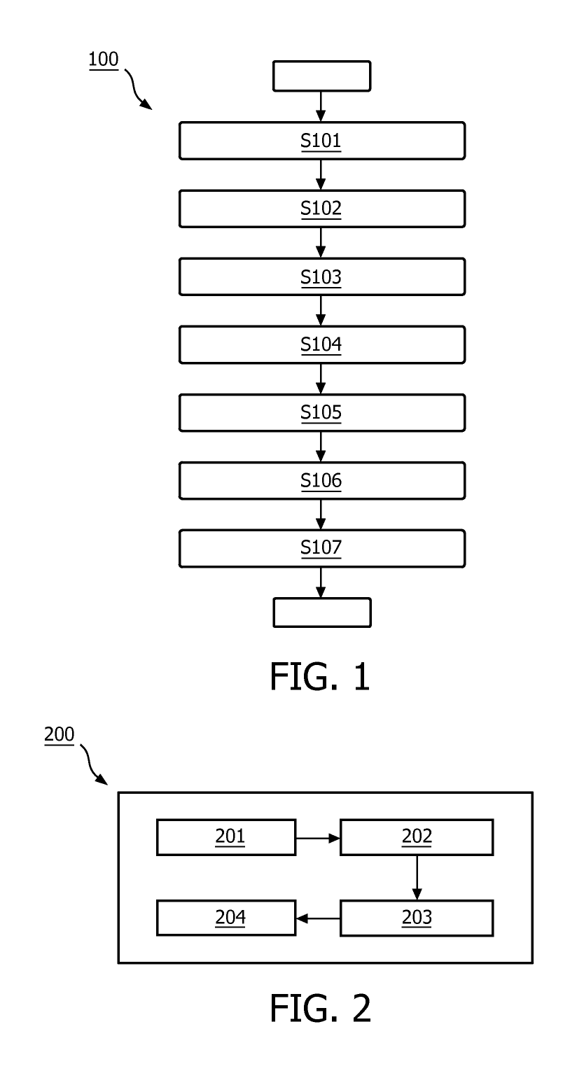

Reference is first made to FIG. 1, where a flowchart of a method 100 for healthcare scheduling in accordance with exemplary embodiments of the present invention is shown.

At step S101, a request (referred to as “appointment request”) to generate an appointment for a target user is received. The target user may be a patient in a follow-up procedure, for example. In some embodiments, the appointment request may be input by the target user. Alternatively, the request may be input by the healthcare practitioner, such as a nurse. In some embodiments, the appointment request may be explicitly input, for example, by operating a control like a button on a user interface of a computer. Alternatively or additionally, the request may be automatically generated from other input such as the clinical observations of a patient indicating that an appointment is required. As another example, the appointment request may be generated by analyzing the follow-up information and/or health information of the target user.

In accordance with embodiments of the present invention, the appointment request may at least include the identification of the target user. As used herein, the term “identification” refers to any one or more information items that may uniquely identify the target user. For example, in some embodiments, the identification may be the number of the ID card of the target user, the docking number of the target user, and so forth. The scope of the invention is not limited in this regard. In addition to the identification, the appointment request may include a profile describing any other aspects of the target user, such as name, age, medical history, treatment information, the follow-up program in which he participates and so forth.

Specifically, in some embodiments, the appointment request may include information that may indicate the health condition of the target user. For example, the appointment request may include one or more symptoms of the target user, such as vertigo, nausea, vomiting, abdominal pain, and so forth. Alternatively or additionally, the health condition may include results of one or more medical test items. For example, in some embodiments, the appointment request may contain the results of various liver function test items. Any other information concerning the health condition of the target user may be contained in the appointment request, and the scope of the invention is not limited in this regard.

In addition to or instead of the health condition, in some embodiments, the appointment request may include follow-up information associated with the target user. In accordance with embodiments of the present invention, the follow-up information may at least indicate the follow-up program which the target user attends. For example, the follow-up program may be identified by its title, code, and so forth. In some embodiments, the follow-up information may further contain the current follow-up status of the target user, a list of preferred resources for the follow-up program, and any other information concerning the follow-up procedure related to the target user.

The health condition and/or the follow-up information input along with the appointment request may be used to facilitate the appointment recommendation, which will be detailed in the following paragraph. It should be noted that the health condition and/or the follow-up information are not necessarily included in the appointment request. Alternatively, such information may be stored in advance in association with the identification of the target user. In such embodiments, the health condition and/or the follow-up information may be retrieved using(?) the identification of the target user.

In response to the receipt of the appointment request, the method 100 proceeds to step S102 where the clinical knowledge associated with the target user is obtained by accessing a knowledge base. Generally speaking, the clinical knowledge comprises the information or date indicating the time constraints on the requested appointment. Further, the clinical knowledge may indicate at least one resource required for the requested appointment. As mentioned above, the resource may include: medical service provider, such as a physician, patient bed, medical device, room, and/or anything required for the appointment. Further, in some embodiments, the clinical knowledge may indicate the type of follow-up program, such as outpatient visit, telephone visit and home visit, and associated resources as required.

In accordance with embodiments of the present invention, the knowledge base is configured to store the clinical knowledge and may be implemented as a Business Process Modeling Notation (BPMN) file, structured file written in Extensive Makeup Language (XML), database file or any other forms of files that may be used to store data. Specifically, in some embodiments, the clinical knowledge base may be implemented as a Drools file. As is known, Drools is a business rule management system (BRMS) with a forward chaining inference based rules engine. Moreover, different portions of the clinical knowledge may be stored within different fields or tags in the knowledge base, such that they can be read and parsed when necessary.

In some embodiments, the clinical knowledge base may include one or more follow-up protocols. A follow-up protocol may indicate time information concerning the appointment nodes in the follow-up program. For example, in some embodiments, the follow-up protocol may indicate the desired appointment time for each appointment node. The desired appointment time may be represented, for example, by its time distance to a reference time such as the discharge time. More specifically, in these embodiments, the appointment time may be stored as values such as “15,” “30,” and “90” (in the unit of days, for example). It means that the appointments should be scheduled fifteen, thirty and ninety days since the discharge date, respectively. Alternatively, in some other embodiments, the appointment time may be represented by the absolute appointment date and possibly time period, such as for example “2014/01/20,” “2014/02/18, 14:00-15:00,” or the like. In this case, the time constraints in the obtained clinical knowledge may comprise an appointment time.

In some embodiments, for each appointment node, the follow-up protocol may further indicate a time window indicating a variable range of the appointment time. For example, in some embodiments, the time window may be represented as a value indicating the maximum permissible time difference to the desired appointment time. As an example, if the value of the time window is “5,” it means that the appointment can be made in a range from five days before the desired appointment time to five days after the desired appointment time. That is, the time window has a length of ten days. In some embodiments, the sign of the value may be used to indicate the relationship of the time window with respect to the desired appointment time. For example, the value “−5” may specify that the appointment can be made five days before the desired appointment time but cannot be scheduled after the desired appointment time. In this case, the time constraints in the obtained clinical knowledge may comprise an appointment time and a time window. As another example, the time window may be specified as an interval like [−5, 10], which means that the appointment can be made from five days before the desired appointment time to ten days after the desired appointment time.

Additionally or alternatively, in accordance with embodiments of the present invention, the clinical knowledge base may include one or more clinical rules. A clinical rule at least indicates a health condition and a corresponding time constraint and/or required resource for the appointments. In other words, a clinical rule maps a health condition to the corresponding time constraint and/or required resource. As discussed above, the health condition may include at least one of the symptoms and results of medical test items. In some embodiments, the clinical rules may be implemented in the form of a table as shown below.

TABLE 1

| Health condition | Time constraint | Resource |
|---|---|---|
| Abnormal AST, ALT, | ASAP | Outpatient physician |
| ALP and GGT in the liver | | |
| function test; and the | | |
| patient is taking statin | | |
| medication. | | |
| Abdominal pain | ADVANCE | B-ultrasonic room |
| . . . | . . . | . . . |

In the example shown in Table 1, the time constraints are divided into several levels such as “ASAP,” “URGENT,” “ADVANCE,” “POSTPONE,” and so forth. As an example, the clinical rule represented by the first entry specifies that if the result of the liver function test indicates that the items AST (glutamic oxalacetic transaminase), ATL (alanine aminotransferase), ALP (alkaline phosphatase) and GGT (gamma-glutamyl transpeptidase) are abnormal and if the patient is taking statin medication, then the appointment should be scheduled as soon as possible (“ASAP”) and an outpatient physician is needed as the resource in this situation. The second clinical rule specifies that if the target user's symptom is abdominal pain, then the appointment should be advanced and a B-ultrasonic room is required as an additional resource.

It should be noted that the example described with reference to Table 1 is only for the purpose of illustration, without limiting the scope of the present invention. For example, in alternative embodiments, the time constraints may be defined as numeric values indicating the degrees of urgency of an appointment. Likewise, the resources may be expressed by means of codes or numbers. Moreover, the clinical rules are not necessarily embodied in the form of a table. For example, in some alternative embodiments, the clinical rules may be implemented as Drools rules.

In some embodiments, the knowledge base may store the clinical knowledge associated with individual users. In such embodiments, at step S102, it is possible to access the knowledge base using the identification of the target user as included in the appointment request received at step S101 to retrieve the follow-up protocol associated with the target user. Furthermore, the health condition of the target user contained in the appointment request (if any) may be used to search for related clinical rules in the knowledge base. Each of the obtained clinical rules indicates the time constraint and/or required resource corresponding to the health condition of the target user. In other embodiments, part or all of the clinical knowledge may be stored on a different basis. For example, in some embodiments, the follow-up protocols may be stored in association with the follow-up programs rather than with the users. In this case, the follow-up protocol may be obtained by using the follow-up information which is included in the appointment request received at step S102 and which at least indicates the follow-up program.

Then, at step S103, a group of prioritized candidate appointments is generated by processing the request at least partially based on the obtained clinical knowledge. In accordance with embodiments of the present invention, each of the candidate appointments may be represented as a tuple comprising the appointment time and the priority. Additionally, the tuple may comprise one or more other information elements.

In some embodiments, a desired appointment time and a time window for the appointment may be determined based on the time constraints for the appointment. For example, in those embodiments where the clinical knowledge includes the follow-up protocol, the desired appointment time may be determined from the follow-up protocol, as described above.

Then, one or more other candidate appointments may be determined in accordance with the time constraints for the appointment based on(?) the obtained clinical knowledge. For example, the one or more other candidate appointments may be determined in accordance with the determined desired appointment and the associated time window. The follow-up protocol may indicate the associated time window in various ways or formats. In an example, the follow-up protocol indicates that the time window is n days, where n is a natural number or zero. Accordingly, the appointment time of the candidate appointments can be determined to range from n days before the desired appointment time to n days after the desired appointment time. In another example, the follow-up protocol indicates that the time window is p days prior to the desired appointment time and q days after the desired appointment time, where p, q are a natural number or zero. Accordingly, the appointment time of the candidate appointments can be determined to range from p days before the desired appointment time to q days after the desired appointment time.

In accordance with embodiments of the present invention, the priority of each candidate appointment may be determined based on the time interval between the appointment time of the candidate appointment and the desired appointment time corresponding to the determined desired appointment. The priority will decrease with increasing time intervals. Specifically, the highest priority may be assigned to the candidate appointment that corresponds to the desired appointment time.

Alternatively or additionally, the clinical rules may be involved in determining the group of prioritized candidate appointments. As described above, in view of the symptom or the result of a medical test of the target user, the desired appointment time and/or the time window may be adjusted. Then the candidate appointments and their priorities may be determined according to the adjusted optimal appointment time and/or the time window. For example, the clinical rule obtained from the rules repository based on a medical test result of the target patient indicates that the target patient's abnormal AST, ALT, ALP and GGT may be a side effect of the statin drug, and so an additional follow up visit should be scheduled as soon as possible. In this case, the desired appointment time may be set to today's date. As another example, the obtained clinical rule may specify that if a patient who attends a gynecological follow-up program has a symptom of abdominal pain, the next appointment shall be postponed by a predetermined number of days. In this case, the desired appointment time should be postponed by the predefined number of days.

Next, the method 100 proceeds to step S104. At step S104, at least one recommended appointment is selected from the group of prioritized candidate appointments based on availability of the at least one required resource. As described above, the required resource(s) for the appointment may be determined based on the clinical knowledge. Additionally, some information contained in the appointment request may be used to determine the required resources. For example, as mentioned above, the profile of the target user may indicate preferred resources such as a preferred physician.

Specifically, in accordance with embodiments of the present invention, the availability of the resources may be checked with respect to the candidate appointments in descending order of the priorities. That is, availability checking is performed starting from the candidate appointments with higher priorities to those with lower priorities.

For any candidate appointment, the availability of a resource may be checked based on the actual usage made of that resource. In accordance with embodiments of the present invention, information about the usage made of the resource may be acquired in many different manners. For example, in some embodiments, the usage made of a resource at the appointment time may be obtained by accessing a log or record that maintains the reservations and usage made of varied resources. In this way, it is possible to identify one or more candidate appointments for which the required resource(s) is (are) available. In some embodiments, the checking of resource availability may terminate once the first available candidate appointment is identified. Alternatively, resource availability may be checked with respect to all the candidate appointments to thereby identify all the candidate appointments for which the resources are available. The identified one or more candidate appointments will be selected as the recommended appointments.

Specifically, in some embodiments it is possible that the required resources are unavailable for all the candidate appointments. In this event, instead of simply returning a failure message, one or more alternative resources may be automatically determined. In some embodiments, the alternative resources may be determined based on their roles. For example, if the available time of the responsible physician does not match the appointment time of any candidate appointment, then it is possible to select one or more other physicians who have the same or similar roles as the originally selected physician. In this way, the method may proceed with checking the availability of the alternative resource against the candidate appointments in descending order of the priorities, in order to select one or more recommended appointments.

In some embodiments, the recommended appointment with the highest priority may be automatically selected as the outcome appointment. The outcome appointment may be output to a user including the target user or a healthcare practitioner such as a nurse or a doctor. In these embodiments, the determined appointment may be displayed to the user via the user interface or may be communicated to the user in any other suitable manner such as telephone. Alternatively, in some other embodiments, the recommended appointments may be displayed to the user at step S105. For example, both the appoint time and the priority of each of the recommended appoints are displayed. In some embodiments, it is possible to only display the recommended appointments out of all the candidate appointments. Or, in other embodiments, all the candidate appointments determined at step S103 may be displayed, with the recommended appointments determined at step S104 highlighted.

For example, in some embodiments, different colors may be used to indicate the availability of the required resources. As an example, a label with green color may be displayed with each recommended appointment to indicate that the required resources are available, while a label with red color may be displayed with the other candidate appointments for which the required resources are unavailable. It should be noted that the use of color is only for the purpose of illustration without limiting the scope of the invention. In other embodiments, the recommended appointment may be distinguished from the other candidate appointments by display locations, backgrounds, shape of labels, and so forth.

The target user and/or the healthcare practitioner such as the nurse may provide an input via the user interface to indicate a selection of a recommended appointment. Such input is received at step S106. For example, the user may select a recommended appointment by clicking a corresponding button or operating any other suitable control(s) on the user interface. In this way, the target user is allowed to determine an appointment from the recommended ones according his/her personal schedule. Responsive to the user selection, the selected recommended appointment will be determined at step S107 as the outcome appointment for the target user.

FIG. 2 shows a block diagram of an apparatus for healthcare scheduling in accordance with embodiments of the present invention. Generally speaking, the apparatus 200 may be configured to carry out steps of the method 100 as discussed above. As shown in the figure, the apparatus 200 comprises a request receiving unit 201 configured to receive a request to generate an appointment for a target user, the request at least containing identification of the target user; a knowledge obtaining unit 202 configured to obtain clinical knowledge associated with the target user by accessing a knowledge base, the clinical knowledge at least indicating time constraints and at least one required resource for the appointment; a candidate generating unit 203 configured to generate a group of prioritized candidate appointments by processing the request at least partially based on the obtained clinical knowledge, each of the candidate appointments being represented at least by appointment time and a priority; and a recommendation selecting unit 204 configured to select at least one recommended appointment from the group of prioritized candidate appointments based on availability of the at least one required resource.

In some embodiments, the request may include health condition of the target user, the condition including at least one of a symptom and a result of a medical test item. In such embodiments, as described above, the clinical knowledge obtained from the knowledge base may include at least one clinical rule that indicates at least one of time constraint and resource corresponding to the health condition.

In some embodiments, the request may include follow-up information of the target user, the follow-up information at least indicating a follow-up program for the target user. Accordingly, the clinical knowledge obtained from the knowledge base may include a follow-up protocol associated with the indicated follow-up program, the follow-up protocol at least indicating a desired appointment time and a time window for the appointment. In some embodiments, the candidate generating unit may be configured to determine a desired appointment time and a time window for the appointment based on the time constraints for the appointment, and to generate the group of prioritized candidate appointments in accordance with the determined desired appointment and the time window, the priority of a given candidate appointment in the group being determined based on a time interval between the appointment time of the given candidate appointment and the desired appointment time.

In some embodiments, the apparatus 200 may include a resource usage acquiring unit configured to acquire actual usage of the at least one required resource for the candidate appointments. Accordingly, the recommendation selecting unit 204 may be configured to determine the at least one recommended appointment based on the actual usage of the at least one required resource. In some embodiments, the selecting unit 204 may be configured to check the availability of the at least one required resource for the candidate appointments in descending order of the priorities to identify at least one candidate appointment for which the at least one required resource is available. Accordingly, the selecting unit 204 may be configured to determine the identified at least one candidate appointment as the at least one recommended appointment for the target user.

In some embodiments, the apparatus 200 may comprise an alternative resource determining unit configured to determine, responsive to the determination that the at least one required resource is unavailable for each of the candidate appointments, at least one alternative resource based on the clinical knowledge. In such embodiments, the candidate selecting unit 204 may be configured to select the at least one recommended appointment from the group of prioritized candidate appointments based on availability of the at least one alternative resource.

In some embodiments, the apparatus 200 may comprise a display unit configured to cause the at least one recommended appointment to be displayed via a user interface; an input receiving unit configured to receive an input via the user interface, the input indicating a selection of a recommended appointment; and an appointment determining unit configured to determine the selected recommended appointment as the appointment for the target user.

It will be understood that the apparatus 200 described above may be implemented as hardware, software/firmware, or any combination thereof. In some embodiments, one or more units in the apparatus 200 may be implemented as software modules. Alternatively or additionally, some or all of the units may be implemented using hardware modules such as integrated circuits (ICs), application specific integrated circuits (ASICs), system-on-chip (SOCs), field programmable gate arrays (FPGAs), and the like. The scope of the present invention is not limited in that regard.

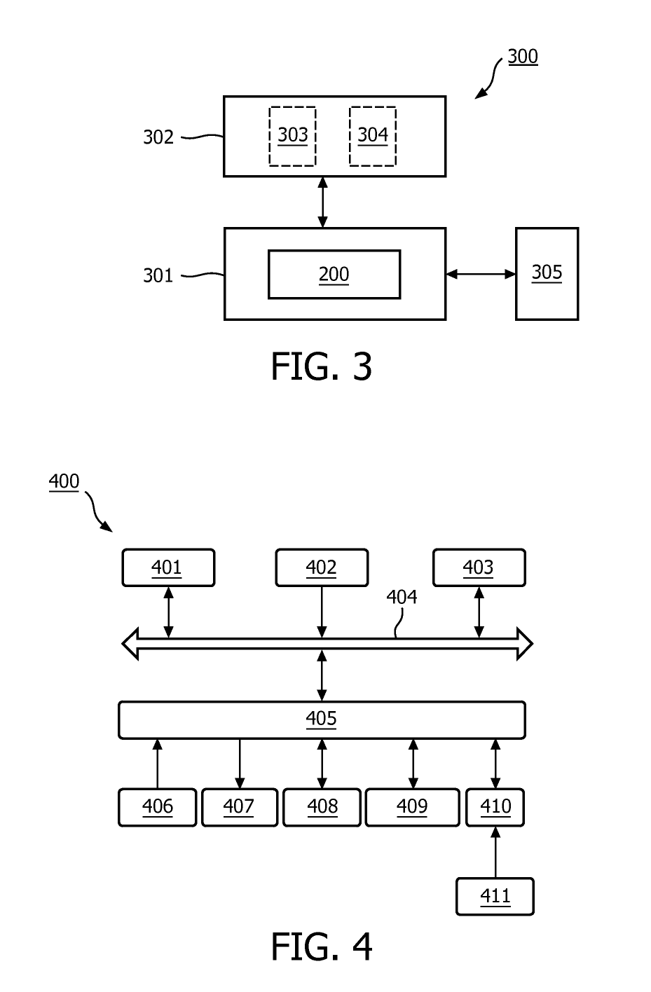

FIG. 3 shows a block diagram of a system for healthcare scheduling in accordance with embodiments of the present invention. As shown in FIG. 3, the system 300 comprises the apparatus 200 as described above. The apparatus 200 may execute its function(s)(?) at a terminal device 301 such as a desktop computer, server, workstation, laptop, and so forth. The system 300 also comprises a knowledge base 302 which is adapted to store the clinical knowledge. As discussed above, the clinical knowledge may at least include the follow-up protocol 303 and the clinical rules 304, for example. As shown, the system 300 further comprises a resource checker 305, which may be configured to store or control the usage of one or more resources and to provide the usage of specified resources to the apparatus 200.

In accordance with embodiments of the present invention, the terminal device 301, the knowledge base 302 and the resource checker 305 may be separate from each other. That is, the system 300 may be implemented as a distributed system. The data may be communicated within the system 300 by means of, for example, a communication network such as a radio frequency (RF) communication network, a computer network such as a local area network (LAN), a wide area network (WAN) or the Internet, a near field communication connection, or any combination thereof. Alternatively, the terminal device 301, the knowledge base 302 and the resource checker 305 may be co-located on the same physical machine. Data communication may be achieved by any suitable internal communication mechanisms such as inter-process communication.

Only for the purpose of illustration, an example where embodiments of the present invention are applied will now be described. In this example, the request to generate an appointment for a patient is input by the research nurse. The request includes a profile of the patient containing the identification of the patient. Additionally, the request includes the follow-up information associated with the user, which indicates that the follow-up program the patient attends is a program after percutaneous coronary intervention (PCI). The follow-up information also includes the current follow-up status and the preferred physician's identification.

Responsive to the appointment request, the clinical knowledge is retrieved from the knowledge base. In this example, the clinical knowledge includes the follow-up protocol from which it is determined that the next appointment time is the sixtieth day since discharge and the length of the time window is 15 days. Accordingly, a group of candidate appointments may be determined and prioritized. Assuming that the 60^{th} day after discharge is Oct. 16, 2013, the candidate appointments are distributed from Oct. 1, 2013 to Oct. 31, 2013. The priority is based on the length of the period from Oct. 16, 2013. The higher the priority that is given, the shorter the length of the time window will be, with the highest priority being given to Oct. 16, 2013.

Then the availability of the required resource(s) determined from the clinical knowledge may be checked, for example, by the resource checker. In this example, the available time of the preferred physician is checked first with respect to the highest priority appointment time, namely, Oct. 16, 2013. If the preferred physician is unavailable for each of the candidate appointments, the availability of another physician which has the same role as the preferred physician will be checked against the candidate appointments. The candidate appointments and the associated availability of the resource will be displayed to the user. In this example, different colors are used to indicate different states of the resource availability. The nurse may ask the patient to select a candidate appointment to complete the scheduling.

FIG. 4 shows a computer 400 suitable for implementing exemplary embodiments of the present invention. For example, the computer 400 may be used to function as the terminal device 301 as discussed above with reference to FIG. 3. As shown, the computer 400 comprises a central processing unit (CPU) 401 which is capable of performing various processes in accordance with a program stored in a read only memory (ROM) 402 or a program loaded from a storage section 408 to a random access memory (RAM) 403. In the RAM 403, data required when the CPU 401 performs the various processes or the like is also stored as required. The CPU 401, the ROM 402 and the RAM 403 are connected to one another via a bus 404. An input/output (I/O) interface 405 is also connected to the bus 404.

The following components are connected to the I/O interface 405: an input section 406 including a keyboard, a mouse, or the like; an output section 407 including a display such as a cathode ray tube (CRT), a liquid crystal display (LCD), or the like, and a loudspeaker or the like; the storage section 408 including a hard disk or the like; and a communication section 409 including a network interface card such as a LAN card, a modem, or the like. The communication section 409 performs a communication process via the network such as the internet. A drive 410 is also connected to the I/O interface 405 as required. A removable medium 411, such as a magnetic disk, an optical disk, a magneto-optical disk, a semiconductor memory, or the like, is mounted on the drive 410 as required, so that a computer program read therefrom is installed into the storage section 408 as required.

Specifically, in accordance with embodiments of the present invention, the method 100 described above with reference to FIG. 1 may be implemented as computer programs. For example, embodiments of the present invention comprise a computer program product for healthcare scheduling. The computer program product is tangibly stored on a non-transient computer-readable medium and comprises machine-executable instructions which, when executed, cause the machine to perform steps of the method 100. In such embodiments, the computer program may be downloaded and installed(?) from the network via the communication section 409, and/or installed from the removable memory section 411.

In general, the various exemplary embodiments may be implemented in hardware or special purpose circuits, software, logic or any combination thereof. Some aspects may be implemented in hardware, while other aspects may be implemented in firmware or software which may be executed by a controller, microprocessor or other computing device. While various aspects of the exemplary embodiments of the present invention are illustrated and described as block diagrams, flowcharts, or using some other pictorial representation, it will be appreciated that the blocks, apparatus, systems, techniques or methods described herein may be implemented, as non-limiting examples, in hardware, software, firmware, special purpose circuits or logic, general purpose hardware or controller or other computing devices, or some combination thereof.

In the context of the present invention, a machine readable medium may be any tangible medium that can contain or store a program for use by or in connection with an instruction execution system, apparatus, or device. The machine readable medium may be a machine readable signal medium or a machine readable storage medium. A machine readable medium may include, but is not limited to, an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Computer program code for carrying out methods of the present invention may be written in any combination of one or more programming languages. These computer program codes may be provided to a processor of a general purpose computer, special purpose computer, or other programmable data processing apparatus, such that the program codes, when executed by the processor of the computer or other programmable data processing apparatus, cause the functions/operations specified in the flowcharts and/or block diagrams to be implemented. The program code may be executed entirely on a computer, partly on the computer, as a stand-alone software package, partly on the computer and partly on a remote computer or entirely on the remote computer or server.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations to the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination.

Various modifications, adaptations to the foregoing exemplary embodiments of this invention may become apparent to those skilled in the relevant arts in view of the foregoing description, when read in conjunction with the accompanying drawings. Any and all modifications will still fall within the scope of the non-limiting and exemplary embodiments of this invention. Furthermore, other embodiments of the inventions set forth herein will come to mind to one skilled in the art to which these embodiments of the invention pertain having the benefit of the teachings presented in the foregoing descriptions and the drawings.

Therefore, it will be appreciated that the embodiments of the invention are not to be limited to the specific embodiments disclosed and that modifications and other embodiments are intended to be included within the scope of the appended claims. Although specific terms are used herein, they are used in a generic and descriptive sense only and not for purposes of limitation.

1. A method (100) of healthcare scheduling, the method comprising the steps of:
receiving (S101) a request to generate an appointment for a target user, the request at least containing identification of the target user;
obtaining (S102) clinical knowledge associated with the target user by accessing a knowledge base (302), the clinical knowledge at least indicating time constraints and at least one required resource for the appointment;
generating (S103) a group of prioritized candidate appointments by processing the request at least partially based on the obtained clinical knowledge, each of the candidate appointments being represented at least by appointment time and a priority; and
selecting (S104) at least one recommended appointment from the group of prioritized candidate appointments based on availability of the at least one required resource.

2. The method according to claim 1, wherein the request includes health condition of the target user, the health condition including at least one of a symptom and a result of a medical test item, and
wherein the clinical knowledge obtained from the knowledge base includes at least one clinical rule (304) associated with the health condition, the at least one clinical rule (304) indicating at least part of the time constraints and the at least one required resource for the appointment.

3. The method according to claim 1, wherein the request includes follow-up information of the target user, the follow-up information at least indicating a follow-up program associated with the target user, and
wherein the clinical knowledge obtained from the knowledge base includes a follow-up protocol (303) associated with the indicated follow-up program, the follow-up protocol indicating at least part of the time constraints and the at least one required resource for the appointment.

4. The method according to claim 1, wherein the time constraints for the appointment comprise a desired appointment time and a time window for the appointment.

5. The method according to claim 1, wherein generating (S103) the group of prioritized candidate appointments comprises:
determining a desired appointment time and a time window for the appointment based on the time constraints for the appointment; and
generating the group of prioritized candidate appointments in accordance with the determined desired appointment time and the time window, the priority of a given candidate appointment in the group being determined based on a time interval between the appointment time of the given candidate appointment and the desired appointment time.

6. The method according to claim 1, wherein selecting (S104) at least one recommended appointment from the group of prioritized candidate appointments comprises:
acquiring the actual usage of the at least one required resource for the candidate appointments; and
selecting the at least one recommended appointment based on the actual usage of the at least one required resource.

7. The method according to claim 1, wherein selecting (S104) at least one recommended appointment from the group of prioritized candidate appointments comprises:
checking the availability of the at least one required resource with respect to the candidate appointments in descending order of the priorities to identify at least one candidate appointment for which the at least one required resource is available; and
determining the identified at least one candidate appointment as the at least one recommended appointment.

8. The method according to claim 7, wherein selecting (S104) at least one recommended appointment from the group of prioritized candidate appointments comprises:
responsive to the determination that the at least one required resource is unavailable for each of the candidate appointments, determining at least one alternative resource based on the clinical knowledge; and
selecting the at least one recommended appointment from the group of prioritized candidate appointments based on availability of the at least one alternative resource.

9. The method according to any of claims 1 to 8, further comprising:
displaying (S105) the at least one recommended appointment via a user interface;
receiving (S106) an input via the user interface, the input indicating a selection of a recommended appointment; and
determining (S107) the selected recommended appointment as the appointment for the target user.

10. The method according to claim 9, wherein displaying (S105) the at least one recommended appointment comprises displaying the appointment time and the priority of each of the at least one recommended appointment.

11. An apparatus (200) for healthcare scheduling, the apparatus comprising:
a request receiving unit (201) configured to receive a request to generate an appointment for a target user, the request at least containing identification of the target user;
a knowledge obtaining unit (202) configured to obtain clinical knowledge associated with the target user by accessing a knowledge base, the clinical knowledge at least indicating time constraints and at least one required resource for the appointment;
a candidate generating unit (203) configured to generate a group of prioritized candidate appointments by processing the request at least partially based on the obtained clinical knowledge, each of the candidate appointments being represented at least by appointment time and a priority; and
a recommendation selecting unit (204) configured to select at least one recommended appointment from the group of prioritized candidate appointments based on availability of the at least one required resource.

12. A system (300) for healthcare scheduling, the system comprising:
the apparatus (200) according to claim 11;
the knowledge base (301) configured to store the clinical knowledge; and
a resource checker (305) configured to store usage of one or more resources and provide the usage of the at least one required resource to the apparatus (200).

13. A computer program product for healthcare scheduling, the computer program product being tangibly stored on a non-transient computer-readable medium and comprising machine executable instructions which, when executed, cause the machine to perform steps of the method according to any one of claims 1 to 10.
